(19) United States
(12) Patent Application Publication
(10) Pub. No.: US 2020/0258151 A1
(43) Pub. Date: Aug. 13, 2020

(54) ASSISTANCE SYSTEM, ASSISTANCE METHOD, AND STORAGE MEDIUM

(71) Applicant: EFIT CO., LTD, Koga-shi, Ibaraki (JP)

(72) Inventor: Katsutoshi MIYAHARA, Koga-Shi, Ibaraki (JP)

(21) Appl. No.: 16/480,478

(22) PCT Filed: Jan. 29, 2018
(86) PCT No.: PCT/JP2018/003709

§ 371 Date: Sep. 20, 2019

(30) Foreign Application Priority Data
Jan. 28, 2017 (JP) 2017-25423

(51) Int. Cl. G06Q 40/04; G06F 16/2458

(52) U.S. Cl. CPC G06Q 40/04; G06F 16/2477

(57) ABSTRACT

Generation of rules for extracting points that can provide meaningful information relating to time-series data in trading of trading objects whose value changes, such as rules for extracting the timing of a trade, would be assisted. An assistance system in one embodiment of the present invention is a system for generating a rule for a computer to extract a time point included in time-series data, including: a memory storing instructions; and a processing device coupled to the memory, configured to execute the instructions to: store a plurality of determination conditions which are used for determining whether or not to extract the time point; extract, based on information input from a user, at least two determination conditions from the determination conditions stored in the storage means, and generating the rule composed of combination of the extracted determination conditions; and output information regarding the generated rule.

### TECHNICAL FIELD

The present invention relates to assistance for users who handle time series data.

### Background Art

An investor who buys and sells stocks may sometimes determine the buying and selling timing on the basis of time-lapse data (i.e., time-series data) of stock prices and the like. Most investors make decisions such as “Is it time to buy/sell now?” or “Should I keep an eye on it?”, like “Stock prices tend to rise/fall easily at such times”, on the basis of past data.

Among investors (including institutional investors such as securities companies), there are investors that cause a computer to extract a timing decided to be a timing when the stocks should be bought/sold on the basis of their own theory. Such trading methods are sometimes called “algorithm trading”, “system trading” or the like. In such methods, the investors construct an algorithm (trading algorithm) so that the computer can extract points determined to be a timing when the stocks should be bought/sold on the basis of unique theories. Then, the investors cause the computer to extract the timing of trading by describing the constructed algorithm by programming.

Non-Patent Literature 1 discloses an example of generating a highly effective trading algorithm by using a plurality of indicators which determine the timing of trading.

Patent Literature 1 discloses an invention relating to a contract simulation system that simulates trading of stocks by an algorithmic trading system.

### CITATION LIST

### Non-Patent Literature

[NPTL 1] Shigeo Mori, et al., “The Stock Price Prediction and Sell-Buy Strategy Model by Genetic Network Programming”, TRANSACTIONS OF THE INSTITUTE OF ELECTRICAL ENGINEERS OF JAPAN PART C (Electronics, Information and Systems Division), 2005, vol. 125, No. 4, pp. 631-636.

### Patent Literature

[PTL 1] Japanese Unexamined Patent Application Publication No. 2009-26225

### SUMMARY OF INVENTION

### Technical Problem

Building and implementing a trading algorithm requires knowledge, familiarity, and time. Especially for beginners, not only is there a barrier that it is difficult to put the algorithm into the programming language, but there is also a barrier that they do not know when it is effective to trade. These barriers make it difficult for novices to enter as investors.

Even for the skilled person, being able to easily and readily generate rules for extracting complex trading timings is valuable for making better algorithms.

Thus, there is a need for a service that facilitates generating rules for extracting the timing of trading.

An exemplary object of the present invention is to provide an apparatus and the like for assisting generation of extraction rules of extracting points that can provide meaningful information regarding time-series data, such as rules for extracting the timing of trading in trading of trading objects whose value fluctuates.

### Solution to Problem

An assistance system according to an embodiment of the present invention is a system for generating a rule for a computer to extract a time point included in time-series data, including: a storage means for storing a plurality of determination conditions which are used for determining whether or not to extract the time point; a generating means for extracting, based on information input from a user, at least two determination conditions from the determination conditions stored in the storage means, and generating the rule composed of combination of the extracted determination conditions; and an output means for outputting information regarding the generated rule.

An assistance method according to an embodiment of the present invention is a method in which a device generates a rule for a computer to extract a time point included in time-series data, the method including: a generating means for extracting, based on information input from a user, at least two determination conditions from a storage means for storing a plurality of determination conditions which are used for determining whether or not to extract the time point; generating the rule composed of combination of the extracted determination conditions; and an output means for outputting information regarding the generated rule.

A storage medium according to an embodiment of the present invention is a computer-readable storage medium storing a program that causes a computer to generate a rule for a computer system to extract a time point included in time-series data, the program causing the computer to: extract, based on information input from a user, at least two determination conditions from a storage means for storing a plurality of determination conditions which are used for determining whether or not to extract the time point; generate the rule composed of combination of the extracted determination conditions; and output information regarding the generated rule.

### Advantageous Effects of Invention

According to the present invention, it is possible to easily obtain an extraction rule of extracting points that can provide meaningful information on time-series data, such as a rule for extracting the timing of trading in trading of a trading object whose value fluctuates.

### BRIEF DESCRIPTION OF DRAWINGS

FIG. 1 is a block diagram illustrating a configuration of a first embodiment of the present invention.

FIG. 2 is a table illustrating a specific example of condition data.

FIG. 3 is a sequence diagram illustrating a process flow of an assistance system and a user terminal according to the first embodiment.

FIG. 4 illustrates an example of a display screen by a display unit.

FIG. 5 illustrates an example of a display screen by the display unit when a type of condition is selected.

FIG. 6 illustrates another example of the display screen by the display unit.

FIG. 7 illustraties an example of display of information on a generated extraction rule.

FIG. 8 is a block diagram illustrating a configuration of a modification of the first embodiment.

FIG. 9 is a block diagram illustrating a configuration of a second modification of the first embodiment.

FIG. 10 is a block diagram illustrating a configuration of a third modification of the first embodiment.

FIG. 11 is a block diagram illustrating a configuration of an assistance system according to a second embodiment of the present invention.

FIG. 12 is a flow chart illustrating a flow of processing of the assistance system according to the second embodiment.

FIG. 13 is a block diagram illustrating a configuration of an assistance system according to one embodiment of the present invention.

FIG. 14 is a flowchart illustrating a process flow of the assistance system according to on e embodiment of the present invention.

FIG. 15 is a block diagram illustrating an example of hardware that achieves parts of each embodiment of the present invention.

### DESCRIPTION OF EMBODIMENTS

Hereinafter, embodiments of the present invention is described in detail with reference to the drawings.

In the present disclosure, a rule for extracting the timing of trading is referred to as an “extraction rule”. The “extraction rule” is, in other words, a determination criterion that defines conditions under which points (timings) are extracted as timings at which buying (or selling) should be performed.

### First Embodiment

First, one embodiment 1 of the present invention is described.

### <Configuration>

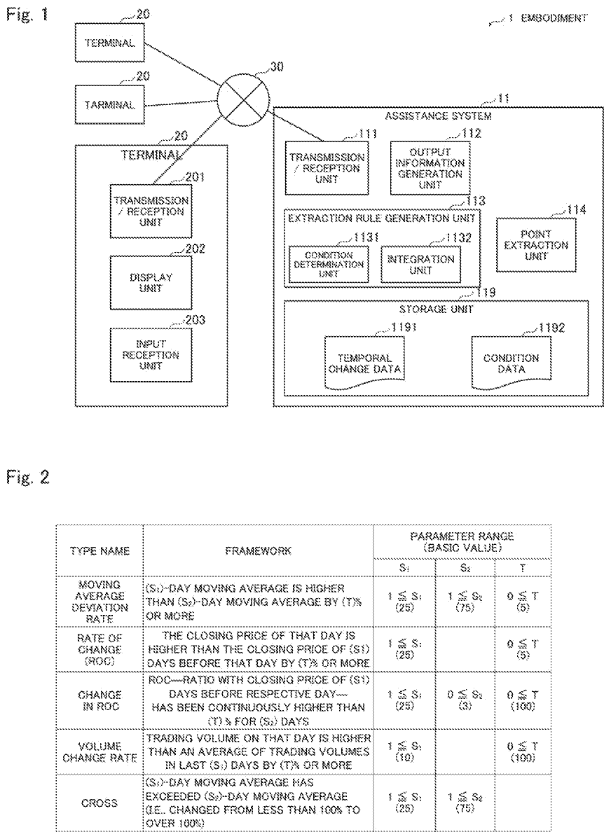

FIG. 1 is a block diagram illustrating a configuration of a first embodiment. In the first embodiment, an assistance system 11 and a user terminal 20 are communicably connected via a network 30.

The network 30 is a communication network including, for example, a Wide Area Network (WAN) and a Local Area Network (LAN), and communicably connects devices that have communication functions. The network 30 may be a wired cable.

The user terminal 20 is a terminal used by a user who receives a service from the assistance system 11. The user terminal 20 includes a transmission/reception unit 201, a display unit 202, and an input reception unit 203. A specific example of the user terminal 20 is a PC (Personal Computer), a tablet, a smartphone or the like.

The transmission/reception unit 201 exchanges data with the assistance system 11.

The display unit 202 displays the data received from the assistance system 11. The display unit 202 is realized by, for example, a liquid crystal display or the like, and provides information to the user by displaying an image. In the present embodiment, “display of an image” is adopted as a form of output of information to the user by the user terminal 20, but as another embodiment, an output form of information other than display of an image (for example, voice presentation, tactile presentation, etc.) may be adopted.

The input reception unit 203 receives an input from the user. The input reception unit 203 is, for example, a keyboard, a mouse, or a touch panel. The input reception unit 203 and the display unit 202 may be integrated as a touch panel.

The assistance system 11 provides a service to the user terminal 20. The assistance system 11 includes a transmission/reception unit 111, an output information generation unit 112, an extraction rule generation unit 113, a point extraction unit 114, and a storage unit 119.

The storage unit 119 stores information. The storage unit 119 may be a database system, or may be a storage device such as a hard disk or a solid state drive (SSD). The information stored by the storage unit 119 includes temporal change data 1191 and condition data 1192.

The temporal change data 1191 is data related to generation of extraction rules and extraction of points (described later). What is particularly assumed as the temporal change data 1191 is, for example, data related to fluctuations in value of trading objects such as stocks, currencies (including virtual currency), precious metals, gems, and real estate. However, the temporal change data 1191 handled by the assistance system 11 is not necessarily limited to the data exemplified above. The assistance system 11 may be applied to a variety of time-lapse data that is worth analyzing, such as climate change, seismograph records, product sales, facility visitor numbers, and the like. For convenience of explanation, time-series data representing fluctuations in stock prices will be assumed below as a representative example of the temporal change data 1191. The temporal change data 1191 is, for example, fluctuation data of stock prices of stock companies (for example, stock listed on the first section of the Tokyo Stock Exchange) capable of real-time trading of stocks over the past several years. The fluctuation data of stock prices includes, for example, daily information of open price, closing price, high and low. The Nikkei Stock Average is also an example of the temporal change data 1191. In addition, the temporal change data 1191 may include time-series data related to trading of stocks. For example, the temporal change data 1191 may include a record of the daily traded volume of each issue. The temporal change data 1191 may not be a daily time series. For example, the temporal change data 1191 may be minute data or weekly data. Moreover, the time series data may not necessarily be data acquired at equal intervals.

Condition data 1192 is data related to the determination condition. The determination condition is a condition for extracting a specific time point in the temporal change data 1191. The determination condition is used to extract a time point included in the temporal change data 1191. As mentioned later, an extraction rule is generated by combination of a plurality of determination conditions.

The determination condition is, so to speak, a statement described immediately after “If” in a determination based on a so-called “If statement”. Examples of the determination condition are “25-day moving average is higher than 75-day moving average by 5% or more”, “the closing price on that day is higher than the closing price on 25 days before that day by 5% or more”, etc. Note that, while the above example is a natural language for the sake of convenience, it goes without saying that the determination conditions can also be described by computer-interpretable expressions.

The determination condition is, for example, a combination of a framework of a conditional statement and a value of a parameter. The parameter defines a type of a value used to extract. The framework of the conditional statement defines a relationship found between parameters (in other words, a outline of the conditional statement). For example, the framework of the determination condition that “the 25-day moving average is higher than the 75-day moving average 5% or more” is “(S1)-day moving average is higher than (S2)-day moving average by (T) % or more” and the parameters are S1, S2 and T. In the present disclosure, the type of the framework of the conditional statement is also referred to as a type of the determination condition (or a “determination condition type”). Determination conditions in which the framework of the conditional statement is the same and the values of the parameters are different are the same kind of determination conditions.

The determination condition is not limited to the condition that targets the transition of the stock price. For example, there may be a determination condition that targets the transition of traded volume. Further, there may be a determination condition that targets PER (Price Earnings Ratio) or national GDP (Gross Domestic Product).

There may be a determination condition that does not include a parameter among the determination conditions.

The condition data 1192 stores, for example, the type name of the determination condition type, the framework of the determination condition, and information on the parameter used for the determination condition, for each type of determination condition. FIG. 2 is a table illustrating contents of the condition data 1192. Although data relating to five determination condition species is illustrated in FIG. 2, the number of determination condition species stored may be more (for example, several tens or several hundreds).

For example, as shown in FIG. 2, the framework of the determination condition of the type where the type name is named “Rate of Change” (ROC) is “The closing price of that day is higher than the closing price of (S1) days before that day by (T) % or more”. As to this type of determination condition, the comparison target day (how many days before that day is the day to be compared) S1 and the threshold value (What percentage of the amount dropped triggers extraction) T are parameters.

As illustrated in FIG. 2, the storage unit 119 may store, for each type of determination condition, a range of parameters used in the determination condition. In addition, the storage unit 119 may store, for each parameter, a basic value (generally used value, a value considered to be effective, and the like) of the parameter as a “basic value”. The basic value is registered, for example, by a manager of the assistance system 11. Alternatively, the basic value may be determined on the basis of statistics of values used by the user who uses the service provided by the assistance system 11. For example, the most frequently used value may be determined as the basic value.

A huge number of determination conditions can be generated on the basis of the condition data 1192 as described above. For example, even if several hundreds of types of determination conditions are stored, there are innumerable combinations of the types and the values of the parameters. Therefore, the storage unit 119 may be interpreted as storing a vast number (or an infinite number) of determination condition groups.

The form of the condition data 1192 described above is an example. As a modification, for example, the storage unit 119 may store, as the condition data 1192, a plurality of determination conditions in which a set of the framework and the value of the parameter is determined.

The transmission/reception unit 111 exchanges data with the user terminal 20.

The output information generation unit 112 generates information (output information) to be output to the user terminal 20. The output information generation unit 112 provides data for the user terminal 20 to output the output information to the user terminal 20 via the transmission/reception unit 111. Displayed images (FIGS. 4, 5, 6 and 7, etc.) by the user terminal 20 described below are generated and displayed on the basis of the information generated by the output information generation unit 112. That is, it can be said that the output information generation unit 112 controls the display of the display unit 202.

The extraction rule generation unit 113 generates an extraction rule. As described above, the extraction rule in the present embodiment is a determination criterion defining which condition triggers extraction of a point (a point included in the temporal change data 1191) as a “timing to buy (or sell)”. That is, the extraction rule is a combination of determination conditions for extracting points.

As shown in FIG. 1, the extraction rule generation unit 113 includes a condition determination unit 1131 and an integration unit 1132.

The condition determination unit 113 determines the determination condition used to gene rate the extraction rule. Specifically, the condition determination unit 113 extracts the determination conditions from a plurality of the determination conditions stored by the storage unit 119 on the basis of, for example, input information from the user. The input information from the user is, for example, information of a determination condition type or determination condition selected by the user. The flow of acquiring input information from the user is described later.

The integration unit 1132 integrates the determination conditions determined by the condition determination unit 113, and generates an extraction rule as a result. Integration means combining the determination conditions.

The point extraction unit 114 extracts points (time points included in the temporal change data 1191) from the temporal change data 1191 on the basis of the extraction rule generated by the extraction rule generation unit 113. That is, the point extraction unit 114 extracts points that satisfy the combination of the determination conditions indicated by the extraction rule from the temporal change data 1191.

Note that “point” (or “point”) extracted by the point extraction unit 114 does not necessarily mean an instant, and may have a certain width. A “point”(or “time point”) can be a period of a minute, a hour, or a day. For example, in a case where the point extraction unit 114 extracts points on the basis of a condition that “the closing price in the previous three days is falling continuously”, the point extraction unit 114 may extract the “day” that corresponds to the next day of the three days in which the closing prices continuously fell as the point. Alternatively, the point extraction unit 114 may extract a certain moment (such as 9 o′clock in the morning) included on the day corresponding to the next day of the three days in which the closing prices continuously fell as the point.

### <Operation>

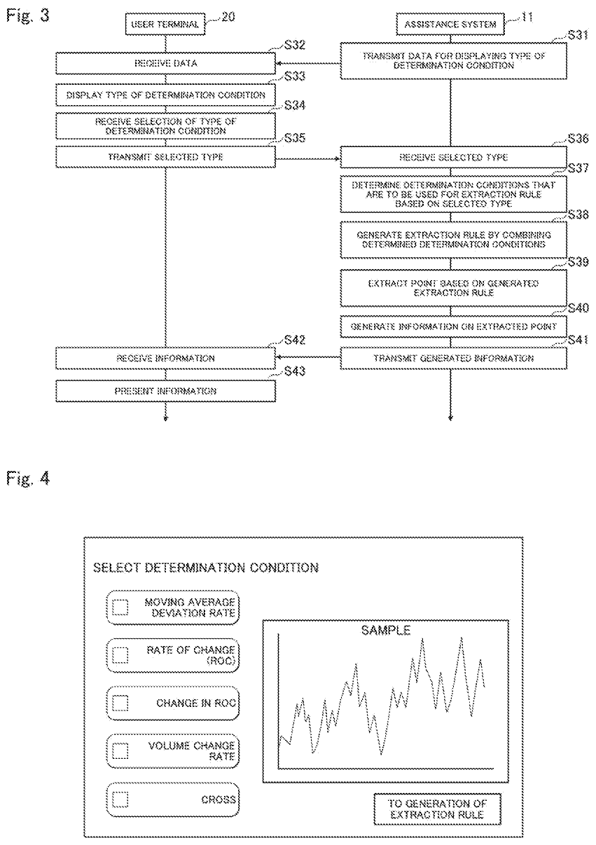

An example of a process flow of the assistance system 11 and the user terminal 20 is described with reference to a sequence diagram shown in FIG. 3.

The user terminal 20 accesses, for example, a particular web site. The assistance system 11 performs the following operation as a web service for the user terminal 20 that has accessed the particular web site.

First, the output information generation unit 112 of the assistance system 11 generates data for displaying an image presenting the determination condition type, and transmits the data to the user terminal 20 (step S31). The transmission/reception unit 201 of the user terminal 20 receives the data (step S32), and the display unit 202 presents the determination condition type by screen display on the basis of the data (step S33). The presentation of the determination condition type is the presentation of an identifier (such as a type name, characters, symbols, images, and the like which depends on the determination condition type) of the determination condition type. The output information generation unit 112 may present representative determination conditions of each type for the sake of the presentation of the determination condition type.

FIG. 4 is an example of an image displayed on the screen of the user terminal 20 by the display unit 202. In the example of FIG. 4, “moving average deviation rate”, “Rate Of Change (ROC)”, “ROC change”, “traded volume change rate”, and “cross” are presented as determination condition types. The determination condition type may not be displayed at once. For example, several types may be presented by screen scrolling or page transition. Each determination condition type is in a state where selection/deselection is available (in the example of FIG. 4, check boxes are attached to each type). The displayed image may include a sample of a transition graph of any stock price, in addition to the determination condition type.

The determination condition types that are displayed may be all types stored in the storage unit 119 or may be some types. The output information generation unit 112 may pick up types to be presented. When the output information generation unit 112 picks up the types to be presented, the types that are picked up may be constant regardless of the user terminal 20, or may be different depending on the feature of the user. An example of picking up the types to be presented based on the characteristics of the user will be described later in the description of ‘Additional Configuration’.

The user of the user terminal 20 selects an preferrable determination condition type among the presented determination condition types. The input reception unit 203 receives a selection of the determination condition type by the user (step S34).

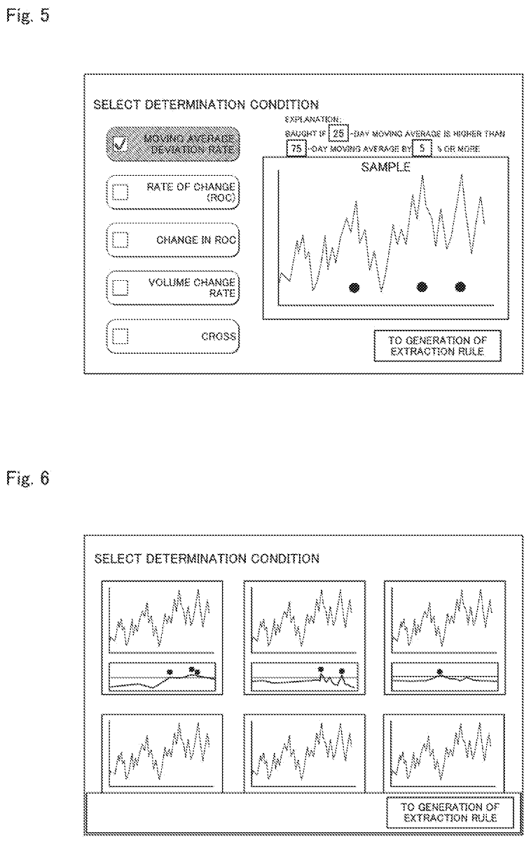

FIG. 5 is an example of a display screen when the user selects the “moving average deviation rate”. For the selected determination condition type, a display that indicates that the determination condition type is being selected may be provided, such as, for example, a check mark being put on the check box next to the identifier of the determination condition type. The determination condition type that has been most recently selected may be emphasized with a color or style or the like different from other determination condition types as shown in FIG. 5.

The method by which the user selects the determination condition type is not limited to the above format. For example, the format of the selection may be a format in which the user moves (for example, by drag and drop) the identifier of the determination condition type to a predetermined area on the screen and it may be determined that the determination condition type is selected. According to such a configuration, it becomes easy to select a plurality of the same determination condition types. The input reception unit 203 may receive the selection of the same determination condition type multiple times.

As illustrated in FIG. 5, the display unit 202 may display an explanation of the selected determination condition type. For example, the display unit 202 may display the framework of the selected determination condition type by natural language or a conditional expression. At this time, examples (for example, basic values) of the values of respective parameters may be displayed together with the framework. In this case, the basic value of each parameter may be transmitted from the output information generation unit 112 at the stage of step S31. Alternatively, when the type is selected, the transmission/reception unit 201 transmits the selected type to the assistance system 11, and the assistance system 11 transmits the basic value of each type of the received type to the user terminal 20. The user terminal 20 may acquire the basic value of each type of parameter.

An example of the parameter value may not necessarily be displayed at this point.

In the display of the framework, instead of the value of the parameter, a character indicating a variable may be displayed.

The display unit 202 may further display data related to the selected determination condition type in the graph of the sample. For example, if the selected determination condition type is “moving average deviation rate”, a graph of moving average values for the last several days (for example, 25 days) at each time point may be superimposed on the display unit 202. In particular, when an example of the value of each parameter is displayed (the determination condition is specifically presented), examples of time points that are extracted based on the determination condition may be shown as shown in FIG. 5. The process of extracting the time points based on the determination condition may be performed by the point extraction unit 114 or may be performed by the user terminal 20.

The display of the data related to the determination condition types in the sample graph may be performed for each of the determination condition types before the user selects the determination condition types. The output information generation unit 112 may display an image showing which points are extracted on the basis of the determination conditions of each type, as shown in FIG. 6. The user may select the determination condition type by selecting an image on the basis of how points are extracted in the sample. In such a case, the image is an identifier of the type.

Those various displays about the determination condition types as help the user to grasp what kind of determination condition type each determination condition type is.

Where an example of the value of a parameter is presented, the value of the parameter may be capable of being changed according to user input. For example, the user may be able to change the displayed value of the parameter by inputting text data or selecting from a list by pull-down. When the value of the parameter is changed, the assistance system 11 may treat the determination condition determined with the changed value as a “selected determination condition”. At this time, the output information generation unit 112 may change the display of the extracted point in the sample to the display of an extracted point based on the determination condition based on the changed value.

As a result of the process described above, the user selects the determination condition type (the determination condition may be specified in some cases). The transmission/reception unit 201 transmits the determination condition type (or the determination condition) selected by the user received by the input reception unit 203 to the assistance system 11 (step S35).

A timing at which the information on the selected determination condition type is transmitted may be immediately after each selection is performed, or may be, for example, a timing when a button “to generation of extraction rule” is selected by the user. Note that the “to generation of extraction rule” button is a button for the user who finished the selection of the type to instruct the assistance system 11 to shift to the generation of the extraction rule.

The transmission/reception unit 111 of the assistance system 11 receives the selected determination condition type or determination condition sent from the user terminal 20 (step S36). The number of types selected by the user is preferably two or more from the viewpoint of generating an extraction rule reflecting the user's individuality. If the button “to generation of extraction rule” is selected when the number of selected types is one or less, the output information generation unit 112 may perform control to output an error indication.

Next, the condition determination unit 1131 of the extraction rule generation unit 113 determines the determination conditions that are to be used to generate the extraction rule on the basis of the determination condition type (and the determination condition) selected by the user (step S37). Specifically, first, the condition determination unit 1131 sets a value of each parameter of the determination condition type selected by the user. As for the determination condition type to which the value of the parameter has already been input by the user, the condition determination unit 1131 may set the setting value to the input value. Also when an example of the value of the parameter has been presented on the screen on which the determination condition type has been selected, the condition determination unit 1131 may set the setting value to the presented value. However, this value may be reset (it may be regarded as a parameter whose value is not determined).

As a method of setting the value of the parameter whose value is not determined, for example, the following methods may be mentioned.
*Set a basic value as a setting value.
*Determine randomly within a defined range.
*Determine randomly from a plurality of prepared values.
According to the random determination method, there is an effect that the generated extraction rules are diversified, that is, it is easy to generate a unique extraction rule. The “defined range” in the method of randomly determining within a defined range may be a range defined separately from the “parameter range” which is exemplified in FIG. 2. In a case of determination by random, the condition determination unit 1131 may weight the likelihood of being determined of each value that can be determined randomly (for example, using a method by which a value closer to the basic value is more prone to be determined).

Next, the integration unit 1132 of the extraction rule generation unit 113 combines the determination conditions determined by the condition determination unit 1131 and thereby generate a n extraction rule (step S38). For example, it is presupposed that the determination conditions determined as the determination conditions to be used are the determination conditions A, B and C. In such a case, the extraction rule generation unit 113 generates, for example, an extraction rule that “specifies (extracts) a point that satisfies the determination conditions A and B and C”. That is, the extraction rule generation unit 113 generates an extraction rule by combining the selected determination conditions. Above-described generation of the extraction rule is an example. The combination of the determination conditions is not limited to the AND condition, but may be an OR condition or a combination including AND and OR.

When the determination condition A and the determination condition B are combined by the AND condition, a point that “satisfies the determination condition A but does not satisfy the determination condition B” is not extracted. This means that the conditions of the points to be extracted become stricter and more extraction rules can be refined.

How the determination conditions are combined (whether they are combined by the AND condition or combined by the OR condition) may be determined in advance for each determination condition type, or may be selectable by the user.

After the extraction rule is generated, the point extraction unit 114 extracts a point from the temporal change data 1191 of the storage unit 110 on the basis of the extraction rule (step S3 9). That is, the point extraction unit 114 extracts a point that satisfies the conditions indicated by the extraction rule. The temporal change data from which a point is extracted may be predetermined may be selected by the user, or may be selected randomly. The point extraction unit 114 may extract a point from the temporal change data 1191 updated in real time. A plurality of temporal change data may be used as temporal change data for which a point is extracted.

Then, the output information generation unit 112 generates information on the extracted point (step S40). The information on the extracted point is, for example, information indicating the extracted point in a graph of the temporal change data from which the point has been extracted. Such information allows the user, for example, to analyze a tendency of fluctuation in the graph after the point extracted under the generated extraction rule.

The information on the extracted point may be, for example, information indicating a tendency of fluctuation in the graph from the point to a predetermined period. For example, the output information generation unit 112 may generate information indicating a value of “rising point rate”. The “rising point rate” may be determined, for example, by calculating a ratio of points—among extracted points—that each satisfies that the stock price at a time point later than the extracted point by a predetermined time point is high. On the Basis of such information, the user is able to judge a validity or an efficacy of the generated extraction rule (whether it is appropriate as an extraction rule for extracting points that are worth being found or indicate a particular tendency).

When “current time point” is extracted from the temporal change data 1191 updated in re al time as a point that satisfies the extraction rule, the output information generation unit 112 may generate output information for displaying the temporal change data 1191 from which the point has been extracted and an indication that the current time point has been extracted (e.g., an indication that “a sign has been issued”, etc.). In this case, the user can know in real time the timing to buy and sell determined on the basis of the extraction rule generated by the user.

The output information generation unit 112 may generate information indicating the configuration of the generated extraction rule, that is, the determination conditions used and the combination way therefor.

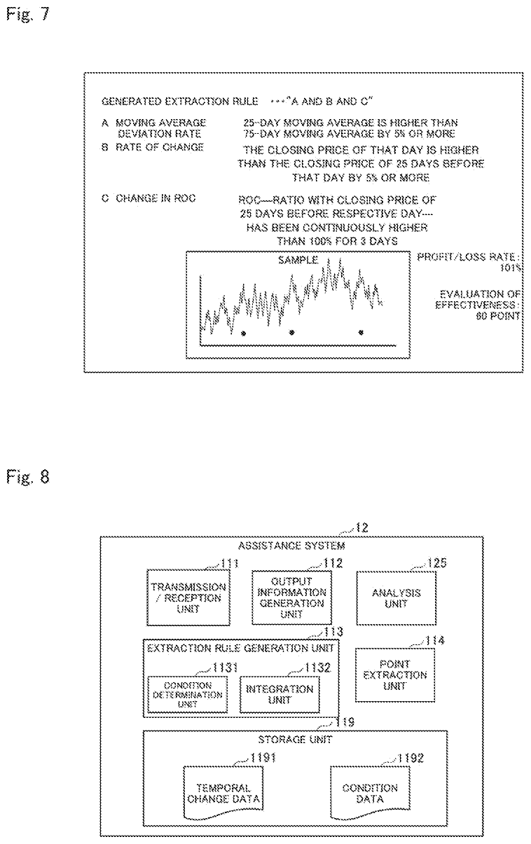

The transmission/reception unit 111 transmits the information generated by the output information generation unit 112 to the user terminal 20 (step S41). The transmission/reception unit 201 of the user terminal 20 receives the information (step S42), and the display unit 202 presents the information to the user by displaying the information (step S43). FIG. 7 is an example of a screen displayed on the display unit 202 by the process of step S43. As shown in FIG. 7, the display unit 202 displays, for example, the details of the extraction rule and information on the evaluation based on the extracted points.

### <Effects>

According to the first embodiment, the user of the user terminal 20 can easily generate an original extraction rule. The extraction rule is generated on the basis of the determination condition type selected by the user, and thus has uniqueness for each user.

Since the determination condition types are presented, the user only needs to select the presented determination condition types, and there is no need to input a complex condition expression. In addition, when the value of the parameter is automatically set only by selection of the determination condition type, it is possible to omit the effort for the user to set the parameter. In such a case, the user can obtain a unique extraction rule only by an action of selecting a determination condition type and an action of pressing a button for determining generation of an extraction rule.

The user can analyze the time series data using the obtained extraction rule. Also, for example, the user can advantageously invest using extraction rules.

Since extraction rules can be easily generated, a user can, for example, easily find out a more useful extraction rule by generating a plurality of extraction rules and comparing their effectiveness and the like.

### <Additional Configuration>

Components that may be useful when added to the first embodiment are hereinafter described.

### [Analysis of Extraction Rule]

An assistance system further including—in addition to the configuration of the assistance system 11—an analysis unit 125, is described as an assistance system 12. FIG. 8 is a block diagram illustrating a configuration of the assistance system 12. The analysis unit 125 perform an analysis to the extraction rule generated by the extraction rule generation unit 113. The analysis unit 125 sends a result of the analysis to the output information generation unit 112.

For example, the analysis unit 125 calculates an index of the effectiveness of the generated extraction rule. In particular, in a case of an extraction rule that targets stock fluctuation data, the index of effectiveness is, for example, an index of profit/loss when stocks are traded on the basis of the generated extraction rule. One example of the index of profit/loss is the above-mentioned “rising point rate”. By knowing the “rising point rate”, the user gets to know degree of likelihood that stocks bought at a timing extracted under the generated extraction rule bring a profit (i.e., that the stock price of the stock goes up) or a loss (i.e., that the stock price of the stock goes up) after a predetermined period. Similarly, the user may also get to know the profit/loss on selling stocks, from the rising point rate.

The analysis unit 125 may calculate various indicators of profit/loss. The analysis unit 1 25 receives the point extracted on the basis of the generated extraction rule from the point extraction unit 114 using the temporal change data 1191. Then, the stock price at the extracted point is compared with the stock price at a point later than the extracted point by a predetermined period, and it is specified whether the stock price goes up (or down) or how much the stock price goes up (or down). As an example, a value obtained by dividing the stock price later than a reference point by the predetermined period by the stock price at the reference point is defined as a “increase rate”. The analysis unit 125 may calculate the increase rate of each of extracted points. Then, the analysis unit 125 may calculate, as the “success rate”, a ratio of points at which the value of the increase rate exceeds a predetermined value (for example, “1.1”) among the points for which the increase rate is calculated. Alternatively, the analysis unit 125 calculates an average of increase rates of extracted points in each of the plurality of temporal change data 1191, and the analysis unit 125 may calculate, as the “success rate”, a ratio of number of temporal change data 1191 on which the average exceeds a predetermined value (for example, 1.1) among used plurality of temporal change data 1191.

The type of analysis for the extraction rules is not limited to the example above. The analysis unit 125 may calculate various statistical information regarding stock trading based on the generated extraction rule. The analysis unit 125 may calculate an evaluation of the extraction rule according to the result of the analysis. For example, the analysis unit 125 may calculate the value of the profit/loss index (the rising point rate, the success rate, etc.) as an evaluation score. A method of calculating the evaluation may be defined on the basis of a measure that is generally regarded as being valid. The analysis unit 125 may calculate, in addition to/instead of the evaluation of the profit/loss index, a frequency with which points are extracted on the basis of the generated extraction rule, the information regarding a risk of damage, and/or an evaluation of effectiveness with respect to them.

The output information generation unit 112 generates information for outputting the result of analysis performed by the analysis unit 125. The result of the analysis may be transmitted to the user terminal 20 via the transmission/reception unit 111 and the transmission/reception unit 201, and may be displayed by the display unit 202 of the user terminal 20. Thereby, for example, the user can get to know a value—that is, a validity—and etc. of the generated extraction rule.

The user may regenerate the extraction rule by reselecting the determination condition type or changing the parameter on the basis of the result of the analysis. By doing so, the user can generate an extraction rule that has characteristics more desirable for the user.

### [Generation of A Plurality of Extraction Rules]

The extraction rule generation unit 113 may generate a plurality of extraction rules. For example, the extraction rule generation unit 113 may generate an “extraction rule for buying” and an “extraction rule for selling”. The extraction rule for buying is a rule for extracting a point that is regarded as a point at which the user should buy the trading object. The extraction rule for selling is a rule for extracting a point that is regarded as a point at which the user should sell the trading object.

The input reception unit 203 may separately (that is, such that they are distinguishable from each other) from the user, the determination condition types to be used for generation of the extraction rule for buying and the determination condition types to be used for generation of the extraction rule for selling. Then, the extraction rule generation unit 113 may generate the “extraction rule for buying” and the “extraction rule for selling” from each determination condition types received separately.

### [Automatic Transaction]

The assistance system 13 is hereinafter described as a system corresponding to the assistance system 11 further including a function of providing a transaction mediation service. The assistance system 13 provides an automatic transaction service. That is, the assistance system 13 may apply the extraction rule generated by the assistance system 13 to the actual stock price, and may trade stocks at an extracted point.

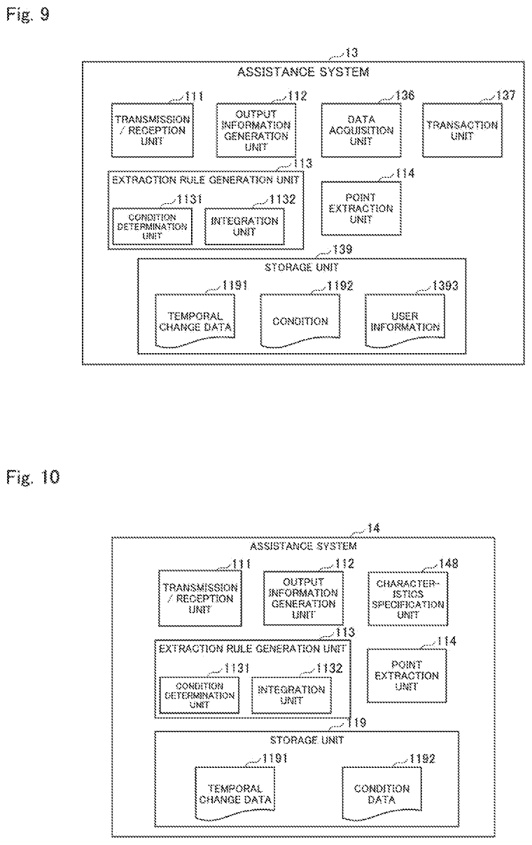

FIG. 9 is a block diagram illustrating the configuration of the assistance system 13. The assistance system 13 includes a data acquisition unit 136 and a transaction unit 137 in addition to the configuration of the assistance system 11 (or the assistance system 12). A storage unit 139 in the assistance system 13 includes user information 1393 in addition to the temporal change data 1191 and the condition data 1192.

The user information 1393 stores information of a user who receives a service of the assistance system 13. The information on the user includes, for example, an ID (Identifier) of the user and a contact address (e-mail address etc.). When an automatic transaction is executed using user's funds, the user's information may include the amount of funds, an account number, and etc.

The data acquisition unit 136 acquires data for generating the temporal change data 1191. Specifically, the data acquisition unit 136 acquires information on an updated stock price as needed. Then, the data acquisition unit 136 updates the temporal change data 1191 and keeps it always in the latest state.

The transaction unit 137 performs, when the current time point is extracted on the basis of the extraction rule in the temporal change data 1191 which is updated as needed, trading of the stock related to the data.

### (Flow of Automatic Trading)

The flow of automatic trading is hereinafter described. After acquiring an extraction rule as a result of a selection of the determination condition type, the user is allowed to request the assistance system 13 for a service for performing an automatic transaction that uses the extraction rule. For example, on the screen displaying the generated extraction rule, a button “to automatic transaction” may be displayed, and the user may select the button. Next, the user makes settings for the automatic transaction. On the screen, for example, a setting screen for setting of contents such as how many shares to buy (or how many shares to sell) when a point is extracted on the basis of the extraction rules, which condition triggers selling (or buying) of stocks having been bought (or sold) may be displayed. Default values may be set as the parameters of setting items. Then, the user may complete a setting through a screen operation and instruct the assistance system 13 to execute an automatic transaction.

The storage unit 139 stores the set items about the automatic transaction requested by the user in such a way that the set items are associated with the user information 1393. Specifically, the user information 1393, the extraction rule to be used, and the set items about the automatic transaction are stored in such a way that they are associated each other.

Thereafter, every time the data acquisition unit 136 acquires the latest data, or at predetermined time intervals, the point extraction unit 114 determines whether a time point (namely, a current time point) at which the latest data is acquired satisfies the condition indicated by the extraction rule. Thus, the point extraction unit 114 extracts a point that satisfies the condition indicated by the extraction rule.

When the point extraction unit 114 extracts a point, the transaction unit 137 trades the stock related to the data from which the point is extracted on the basis of the setting of the user. In addition, the transaction unit 137 may further buy and sell the bought and sold stocks at timing when the condition are satisfied, in accordance with the setting of the user.

The transaction unit 137 may only instruct a system that buys and sells stocks with the user's funds to perform trading according to an instruction of the transaction unit 137. The transaction unit 137 may be configured to control trading of stocks at the time extracted on the basis of the extraction rule.

According to the configuration of the automatic transaction, it is possible to actually operate the user's funds by using the extraction rule generated by the user using the assistance system.

### (Modification)

The assistance system 13 may perform an automatic transaction in a pseudo manner. That is, the transaction unit 137 may simulate fictitious money, and perform an temporary simulation of the fluctuation of money when the automatic transaction is performed on the basis of the extraction rule of the user. The assistance system 13 may transmit a result of the simulation to a contact address of the user. By doing so, the user can determine the validity of the extraction rule that the user has generated. Note that the result of the simulation may include information of the evaluation calculated by the analysis unit 125.

In particular, in an embodiment in which the “extraction rule for buying” and the “extract on rule for selling” are generated, if the transaction amount at each time of extraction is set, it is possible to know how the asset amount changes. The extraction rule generation unit 113 may determine, for example, the trading amount (or trading amount) at each time point, and may generate a “trading rule”, which is an extraction rule including the setting of the transaction amount. The extraction rule generation unit 113 may determine the trading amount, for example, on the basis of an amount setting rule that is predetermined. For example, the input reception unit 203 receives designation of an amount setting rule desired by the user from the user at any timing. The amount setting rule is, for example, “Buy as much as possible with a limit of 30% of the on-hand funds (available money) in case of purchase. Sell as much as possible with a limit of 30% of the amount of assets (the amount including money on hand and the price of shares held)”. The extraction rule generation unit 113 may automatically set the transaction amount in each transaction according to the amount setting rule.

In an embodiment in which a trading rule may be determined as described above, the analysis unit 125 may calculate an evaluation of the trading rule. For example, the analysis unit 125 may calculate a value indicating how much a total asset amount has increased as a score.

### [Rectification of Extraction Rule]

A plurality of extraction rules may be generated based on the selection of the determination condition type by the user. For example, the extraction rule generation unit 113 may generate an extraction rule in which the extraction rule initially generated on the basis of user' s selection of the determination condition type is rectified.

Rectifying the extraction rule means, for example, excluding a determination condition included in the extraction rule from the extraction rule, further including a determination condition in the extraction rule, changing a parameter of a determination condition included in the extraction rule, And so on.

Hereinafter, as an example, an example is described in which the extraction rule generation unit 113 performs processing of further including a determination condition in the extraction rule.

First, the extraction rule generation unit 113 generates a first extraction rule based only on the determination condition determined on the basis of the determination condition type selected by the user, as in steps S38 and S39 described above. Then, the extraction rule generation unit 113 selects (extracts) one or more determination conditions from the condition data 1192 included in the storage unit 119, and adds the selected determination condition(s) to the first extraction rule.

The extraction rule generation unit 113 may select the determination condition to be added on the basis of the first extraction rule. Specifically, for example, the extraction rule generation unit 113 may select a determination condition which brings an extraction rule having an effectiveness (evaluation calculated by the analysis unit 125) higher than the first extraction rule by added to the first extraction rule. For that purpose, for example, the extraction rule generation unit 113 may compare the evaluation of the first extraction rule to evaluations of extraction rules that would be generated when each of the determination conditions in the condition data 1192 is tentatively added to the first extraction rule. When the determination condition including the parameter is added, the extraction rule generation unit 113 may specify a value of the parameter which brings a better evaluation, and add the determination condition using the specified parameter.

As described above, the extraction rule generation unit 113 generates an extraction rule which is generated by adding a determination condition(s) to the first extraction rule. Such a rectified extraction rule is taken as a second extraction rule.

Also in a case of excluding a determination condition included in the extraction rule, the extraction rule generation unit 113 may exclude the determination condition so that the evaluation of the extraction rule becomes better. For example, the extraction rule generation unit 113 generates extraction rules which are generated by excluding respective determination conditions included in the first extraction rule, and causes the analysis unit 125 to calculate the evaluation of each of the extraction rules. When there is an extraction rule having a higher evaluation than the first extraction rule among the generated extraction rules, the extraction rule generation unit 113 determines the extraction rule as a second extraction rule.

In a case of changing the parameter of the determination condition included in the extraction rule, the extraction rule generation unit 113 may modify the parameter so that the evaluation of the extraction rule becomes better. For example, the extraction rule generation unit 113 selects one of the determination conditions included in the first extraction rule, identifies one parameter included in the selected determination condition, and causes the analysis unit 125 to calculate the evaluation of an extraction rule in which the value of the parameter is tentatively changed. If the evaluation of the extraction rule in a case where the value of the parameter is changed is better than the evaluation of the original extraction rule, the extraction rule generation unit 113 determines the extraction rule in which the value of the parameter is changed as the second extraction rule.

The extraction rule generation unit 113 may generate a third extraction rule and a fourth extraction rule by further performing the rectification to the second extraction rule.

The output information generation unit 112 may transmit to the user terminal 20 information that a rectified extraction rule has been generated. When the assistance system includes the analysis unit 125, a result of an analysis on the rectified extraction rule may be transmitted.

The storage unit 139 may store the rectified extraction rule in a manner that the rectified extraction rule is associated with the user who generated the original extraction rule.

The configuration for rectifying the extraction rule further provides the user with an opportunity to obtain favorite extraction rules. In particular, if the rectification is performed to improve the evaluation of the index of loss, such as the success rate, it is possible to obtain a extraction rule with higher quality (i.e., a profit is expected, effectiveness is high).

The output information generation unit 112 may not include the contents (combination of conditions) of the rectified extraction rule in the output information. Even if details of the rectified extraction rule are not displayed, it is sufficient for the user if the result of the analysis of the generated extraction rule is displayed, or if the generated extraction rule is able to be used as “extraction rule A” or the like in an automatic transaction etc.

The condition determination unit 1131 may perform part of the processing of the extraction rule generation unit 113 described above (addition, deletion, and/or parameter modification of the determination condition). The extraction rule generation unit 113 may add, delete, and/or modify the parameter of the determination condition with respect to the type of the determination condition (or the determination condition) selected by the user at the stage of step S37.

### [Process Using User Characteristics]

In the process of each unit described above, a process using characteristics of the user may be performed. The following describes an assistance system 14 that performs processing using the characteristics of the user.

FIG. 10 is a block diagram illustrating a configuration of the assistance system 14. The assistance system 14 includes a characteristics specification unit 148 in addition to components similar to those in the assistance systems 11 to 13.

The characteristics specification unit 148 specifies characteristics of the user. The characteristics of the user may include quantitative characteristics such as gender, age, and assets of the user, and qualitative characteristics such as personality and preference of the user. For example, the output information generation unit 112 of the assistance system 14 presents, to the user, a question regarding personality, financial ability, preference, tendency of thinking, and the like. Examples of questions include “How many years do you plan to work?” and “What do you do in this case?”. Then, on the basis of the user's answer to the question, the characteristics specification unit 148 specifies the characteristics of the user. The characteristics specification unit 148 may estimate the user's personality, financial ability, and preference on the basis of registered information (such as gender) of the user and information indicating a relationship between the information and personality, financial ability, and preference.

When the characteristics of the user is identified, various processes using the characteristics of the user may be performed. Specific examples are presented below.

1. At the Time of Presentation of the Type of the Condition

The output information generation unit 112 may adjust the output information so that the determination condition that suits the user's characteristics is preferentially presented. For example, the output information generation unit 112 extracts the type of the determination condition that suits the user's preference, and set an order of displayed types in a screen for selection of types so that the extracted type is displayed at a position higher than the type that has not been extracted. The output information generation unit 112 may add an indication indicating “recommended” to the extracted type. This facilitates generation of an extraction rule that suits the user's individuality.

2. Determination of the Value of the Parameter

The condition determination unit 1131 may set the value of the parameter in accordance with the characteristics of the user. As one example, the condition determination unit 1131 may change a method of determining the value so that the higher the target amount is, the more prone to be set to be a high value a threshold is. This facilitates generation of an extraction rule that suits the user's individuality.

3. Rectification of the Extraction Rule

The extraction rule generation unit 113 may rectify the extraction rule according to the characteristics of the user. For example, the extraction rule generation unit 113 may generate a second extraction rule so that the second extraction rule has features favored by the user than those of the first extraction rule.

4. Calculation of an Evaluation

The analysis unit 125 may calculate an evaluation of a degree of suitability for the preference of the user. When the amount of money of the user is known, the analysis unit 125 may calculate the bankruptcy probability.

5. Generation of the Trading Rule

The extraction rule generation unit 113 may generate a trading rule according to the characteristics of the user.

As described above, according to the assistance system 14, it is possible to provide a service with high satisfaction for each user.

The above additional configurations may be freely combined. For example, an assistance system according to one embodiment may include the transmission/reception unit 111, the output information generation unit 112, the extraction rule generation unit 113 having a function of rectifying an extraction rule, the point extraction unit 114, the analysis unit 125, the data acquisition unit 136, the transaction unit 137, the characteristics specification unit 148, and the storage unit 139.

### Second Embodiment

A second embodiment of the present invention is hereinafter described.

In the second embodiment, the assistance system has an input/output interface. The user performs selection of conditions and the like through the input/output interface of the assistance system, and receives a service regarding generation of an extraction rule.

FIG. 11 is a block diagram illustrating a configuration of an assistance system 40 according to the second embodiment. The assistance system 40 includes the same components as those of the assistance systems 11 to 14 of the first embodiment—in FIG. 11, the assistance system 40 includes the same components as those of the assistance system 11—except for the transmission/reception unit 111. Instead of the transmission/reception unit 111, the assistance system 40 includes an input/output interface 401.

Descriptions of components similar to those of the assistance system 11 are omitted.

The input/output interface 401 outputs (displays) the screen information generated by the output information generation unit 112 and receives an input from the user. The input/output interface 401 is, for example, a touch panel. The input/output interface 401 may be a combination of an input interface (mouse, keyboard or the like) and an output interface (display or the like).

Each function of each unit of the assistance system 40 is achieved by, for example, a program loaded into a memory. The program may be acquired from an external device via the Internet or the like, or a storage medium on which the program is recorded may be read by a reading device or the like. Some functions may be provided from an external device. For example, various information stored in the storage unit 119 may be held by an external device and read out by the assistance system 40 as needed.

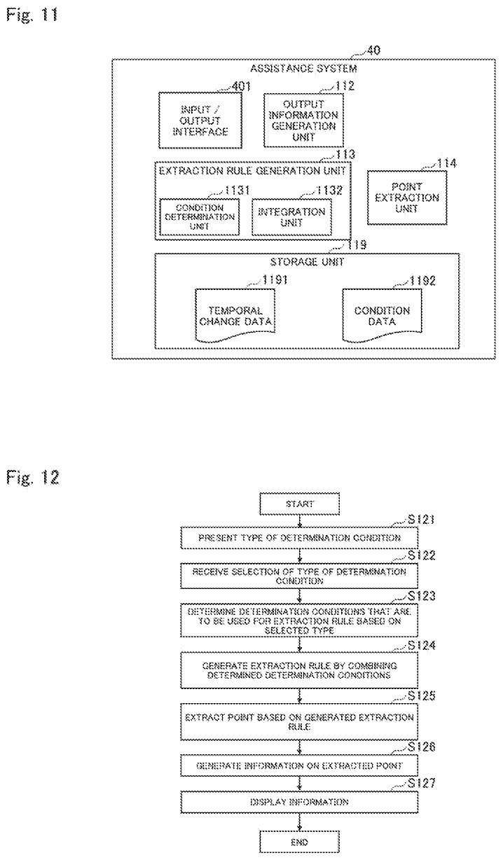

FIG. 12 is a flowchart illustrating a process flow of the assistance system. Contents of the process would be understood in the same manner as the process described in the sequence diagram of FIG. 3. First, the input/output interface 401 outputs the output information generated by the output information generation unit 112 and thereby present the type of the determination condition to the user (step S121). Then, the input/output interface 401 receives a selection of the type of determination condition from the user (step S122). The extraction rule generation unit 113 determines the conditions that are to be used for the extraction rule on the basis of the selected type (step S123). Then, the extraction rule generation unit 113 generates an extraction rule by combining the determined conditions (step S124). Next, the point extraction unit 114 extracts a point on the basis of the generated extraction rule (step S125). Then, the output information generation unit 112 generates information on the extracted point (step S126). Then, the input/output interface 401 presents the generated information as an output (step S127).

Also in the second embodiment, the same effect as that of the first embodiment is obtained.

### One Embodiment

An assistance system 10 according to one embodiment of the present invention is hereinafter described.

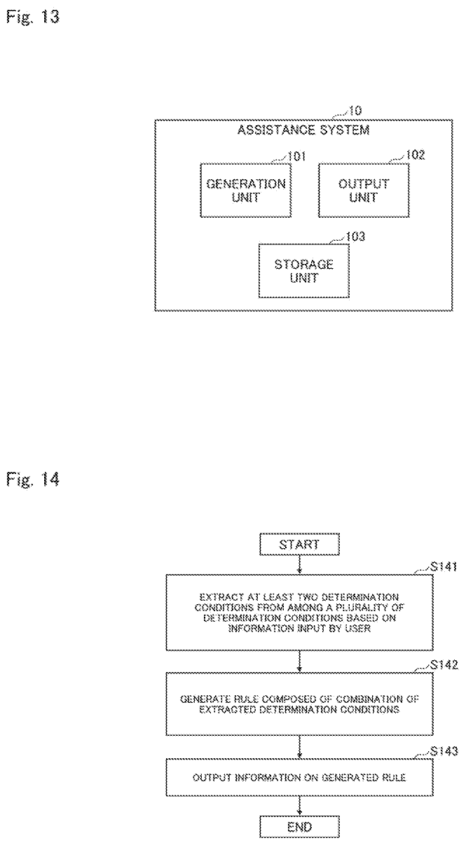

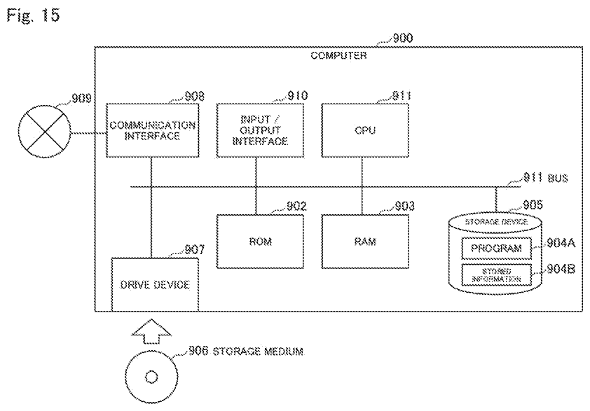

FIG. 13 is a block diagram illustrating a configuration of the assistance system 10. The assistance system 10 includes a generation unit 101, an output unit 102, and a storage unit 103. The generation unit 101 and the output unit 102 are, for example, a server or a terminal on which a given program is installed. The storage unit 103 is, for example, a database system.

The storage unit 103 stores a plurality of determination conditions. The determination condition is a condition used for determining whether or not to extract each time point included in time-series data.

The generation unit 101 extracts at least two determination conditions from among a plurality of determination conditions on the basis of information input from a user.

The generation unit 101 generates a rule composed of combination of the extracted determination conditions. This rule is a rule by which a computer extracts a time point(s) included in time-series data. The time-series data may be any time-series data as long as it is worth being analyzed. For example, time-varying data on a value of a trade, such as stock price fluctuation data or currency fluctuation data, is regarded as the time-series data. The extraction rule generation unit 113 of each of the above-described embodiments is an example of the generation unit 101.

The output unit 102 outputs information on the generated rule. For example, the output unit 102 outputs information on a point(s) extracted on the basis of the generated rule. The output information generation unit 112, the transmission/reception unit 111, and the input/output interface 401 in each of the above-described embodiments are an example of the output unit 102.

FIG. 14 is a flowchart illustrating a flow of processing of each part of the assistance system 10. First, the generation unit 101 extracts at least two determination conditions from among the plurality of determination conditions stored in the storage unit 103 one the basis of information input from a user (step S141). Next, the generation unit 101 generates a rule composed of combination of extracted determination conditions (step S142). Then, the output unit 102 outputs information on the generated rule (step S143).

According to the assistance system 10 according to the present embodiment, an extraction rule for extracting a point(s) that can provide meaningful information regarding time-series data, such as a rules for extracting the timing of trading in trading of trading objects whose value fluctuates, can be easily obtained.

Since the generation unit 101 extracts determination conditions on the basis of user's input, the user does not need a complicated input regarding the determination condition. Since a rule made up of the extracted determination conditions is generated, the user can easily obtain the rule.

The generation of rules using at least two determination conditions diversifies rules that can be generated. By using the determination conditions based on the user's input, the obtained rule is a rule depending on the user's input information, that is, a user-oriented rule. The user can obtain so-called original rules.

In an situation where the user's input information can be obtained by the user selecting an preferable type(s) from the types of determination conditions presented to the user, the user obtains the rule only by selecting at most the type.

<Configuration about Hardware Achieving Each Unit According to Example Embodiments>

In each example embodiment of the present invention described above, each of the constituent elements of each apparatus is denoted by a block for each function.

The processing of each constituent element may be achieved, for example, by causing a computer system to read and execute a program which causes the computer system to execute the processing, which is stored in a computer-readable storage medium. The “computer-readable storage medium” is, for example, a portable medium such as an optical disk, a magnetic disk, a magneto-optical disk, and a nonvolatile semiconductor memory, and a storage medium such as a ROM (Read Only Memory) and a hard disk built in the computer system. The examples of the “computer-readable storage medium” include those that hold a program dynamically for a short time, such as, for example, a communication line for sending a program via a network such as the Internet and a communication line such as a telephone line, and include those that temporarily hold a program such as a volatile memory inside a computer system that corresponds to a server and a client in an embodiment where the program is transmitted via a network or a communication link. The program may be a program that achieves part of the above-described functions, and further may be a program that achieves the above-described function in combination with one or more programs that are already stored in the computer system.

A non-limiting example of the “computer system” is a system including a computer 900 as shown in FIG. 9. The computer 900 includes the following components:
one or more CPUs (Central Processing Units) 901;
a ROM 902;
a RAM (Random Access Memory) 903;
a program 904A and stored information 904B that is to be loaded to RAM 903;
a storage device 905 storing therein the program 904A and the stored information 904B;
a drive device 907 for reading and/or writing data from/into storage medium 906;
a communication interface 908 connected to a communication network 909;
an input/output interface 910 for inputting and outputting data;
a bus 911 for connecting each constituent element;

For example, each constituent element of each apparatus according to each example embodiment is achieved by the CPU 901 loading the program 904A for achieving the function of the constituent element into the RAM 903 and executing the program 904A. The program 904A which for achieving the function of each constituent element of each apparatus is stored in, for example, the storage device 905 or the ROM 902 in advance. The CPU 901 reads the program 904A as necessary. The storage device 905 is, for example, a hard disk. The program 904A may be supplied to the CPU 901 via the communication network 909 or may be stored in advance in the storage medium 906 and may be read out to the drive apparatus 907 and supplied to the CPU 901. The storage medium 906 is, for example, a portable medium such as an optical disk, a magnetic disk, a magneto-optical disk, and a nonvolatile semiconductor memory.

There are various modifications in the method for implementing each apparatus. For example, each apparatus may be achieved by a possible combination of computers 900 and programs individually provided for the constituent elements. A plurality of constituent elements of each apparatus may be achieved by an available combination of one computer 900 and a program.

Some or all of the constituent elements of each apparatus may be achieved by other general-purpose or dedicated circuit, computer, and the like, or a combination thereof. Some or all of the constituent elements may be achieved by a single chip or may be achieved by a plurality of chips connected to one another via a bus.

In an embodiment where some or all of the constituent elements of each apparatus are achieved by a plurality of computers, circuits, and/or the like, the plurality of computers, circuits, and/or the like may be arranged centrally or in a distributed manner. For example, the plurality of computers, circuits, and/or the like may be achieved in a form in which they are connected via a communication network, such as a client and server system, a cloud computing system, and the like.

The present invention is not limited to the above-described example embodiments. It will be understood by those of ordinary skill in the art that various changes in form and details may be made therein without departing from the spirit and scope of the present invention.

This application claims priority based on Japanese Patent Application No. 2017-25423, filed on Jan. 28, 2017, the entire disclosure of which is incorporated herein.

### REFERENCE SIGNS LIST

10-14, 40 assistance system
20 user terminal
30 communication network
101 generation unit
102 output unit
103 storage unit
111 transmission/reception unit
112 output information generation unit
113 extraction rule generation unit
1131 condition determination unit
1132 integration unit
114 point extraction unit
119, 139 storage unit
125 analysis unit
136 data acquisition unit
137 transaction unit
148 feature determination unit
201 transmission/reception unit
202 display unit
203 input reception unit
401 input/output interface
1191 temporal change data
1192 condition data
1393 user information
900 computer
901 CPU
902 ROM
903 RAM
904A program
904B stored information
905 storage device
906 storage medium
907 drive device
908 communication interface

1. An assistance system for generating a rule for a computer to extract a time point included in time-series data, comprising:
memory storing instructions;
a storage storing a plurality of determination conditions which are used for determining whether or not to extract the time point; and
a processing device coupled to the memory, configured to execute the instructions to:
extract, based on information input from a user, at least two determination conditions from the determination conditions stored in the storage, and generating the rule composed of combination of the extracted determination conditions; and
output information regarding the generated rule.

2. The assistance system according to claim 1, wherein the processing device is further configured to:
cause a device capable of input and output to present identifiers of types of the determination conditions and to receive selection of an identifier from a user of the device;
determine, for each identifier selected by the user, a value of a parameter being to be used for a determination condition whose type is identified by the identifier; and
extract, as the determination condition that composes the rule, the determination condition that corresponds to the determination condition whose type is identified by the identifier selected by the user and that uses the determined value of the parameter.

3. The assistance system according to claim 2, wherein the processing device is further configured to:
generate a second rule by extracting extracts an additional determination condition from the storage and adding the additional determination condition to a first rule composed of combination of the determination conditions extracted based on the identifier selected by the user.

4. The assistance system according to claim 3, wherein the processing device is further configured to:
perform evaluation for the first rule and the second rule based on a relationship between increase/decrease in data value of the time-series data and the time point extracted by the first rule or the second rule; extract the additional determination condition and adds the additional determination condition to the first rule so that the second rule having a higher evaluation than the evaluation of the first rule is generated.

5. The assistance system according to claim 2, wherein the processing device is further configured to, in determining the value of the parameter, randomly determine the value of the parameter within a defined range.

6. The assistance system according to claim 1, wherein the processing device is further configured to generate the rule by combining the extracted at least two determination conditions with an AND condition.

7. The assistance system according to claim 1, wherein the time-series data is time-series data indicating a change in value of a target that can be bought and sold, and the processing device is configured to generate a transaction rule which is a transaction rule for buying and selling the object at the time point extracted under the rule.

8. The assistance system according to claim 2, wherein the processing device is further configured to determine the identifier that is to be presented according to characteristics of the user.

9. The assistance system according to claim 2, wherein the processing device is further configured to determine the value of the parameter based on characteristics of the user in determining the value of the parameter.

10. The assistance system according to claim 3, wherein the processing device is further configured to determine the type of the determination condition that is to be added based on characteristics of the user when generating the second rule.

11. A method in which a device generates a rule for a computer to extract a time point included in time-series data, the method comprising:
extracting, based on information input from a user, at least two determination conditions from a storage storing a plurality of determination conditions which are used for determining whether or not to extract the time point;
generating the rule composed of combination of the extracted determination conditions; and
outputting information regarding the generated rule.

12. A non-transitory computer-readable storage medium storing a program that causes a computer to generate a rule for a computer system to extract a time point included in time-series data, the program causing the computer to:
extract, based on information input from a user, at least two determination conditions from a storage storing a plurality of determination conditions which are used for determining whether or not to extract the time point;
generate the rule composed of combination of the extracted determination conditions; and output information regarding the generated rule.
